(19) United States
(12) Patent Application Publication
(10) Pub. No.: US 2026/0233638 A1
(43) Pub. Date: Aug. 13, 2026

(54) SUSPENSION SEATING SYSTEM AND METHODS

(71) Applicant: TMI Products, Inc, Corona, CA (US)

(72) Inventors: Eugene Tuccinardi, Corona, CA (US); Zachary Tuccinardi, Corona, CA (US)

(73) Assignee: TMI Products, Inc., Corona, CA (US)

(21) Appl. No.: 19/534,441

(22) Filed: Feb. 9, 2026

Related U.S. Application Data
(60) Provisional application No. 63/756,572, filed on Feb. 10, 2025.

(51) Int. Cl. B60N 2/015

(52) U.S. Cl. CPC B60N 2/015

(57) ABSTRACT

A system and methods are provided for a suspension seating system for improving the comfort of vehicle occupants traveling over rough terrain. The seating system comprises a suspension system coupled with a seat frame configured to be covered by a suitable padding material. The seat frame can comprise a seat base, a seat back, or a combination thereof. The suspension system includes transverse straps that are interlaced with longitudinal straps. The straps are suspended across the suspension system by support rods coupled with opposite sides of the seat frame by adjustable fasteners. The adjustable fasteners enable aligning the support rods to arrange the transverse and longitudinal straps across the length and width of the suspension system. The adjustable fasteners can include a spring mechanism for maintaining the suspension system under an optimal tension to extend the longevity of the suspension seating system.

### PRIORITY

This application claims the benefit of and priority to U.S. Provisional Application, entitled “Suspension Seating System and Methods,” filed on Feb. 10, 2025, and having application Ser. No. 63/756,572, the entirety of said application being incorporated herein by reference.

### FIELD

Embodiments of the present disclosure generally relate to vehicle seating. More specifically, embodiments of the disclosure relate to a system and methods for a suspension seat for improving the comfort of vehicle occupants traveling over rough terrain.

### BACKGROUND

Off-road suspension seats, such as those often used in UTVs, enhance rider comfort and safety by isolating the driver from the harsh vibrations and impacts encountered during off-road travel. Suspension seats typically incorporate a system of springs, dampers, or a combination of both. Spring-based systems absorb initial impacts due to bumps by compressing, while damper-based systems control the seat's rebound, preventing excessive bouncing. Combined systems are intended to optimize performance by offering a balance of springs and damper-based systems. Suspension seats significantly reduce driver fatigue, improve overall comfort, and minimize the risk of injuries caused by continual jolting, ultimately leading to a more enjoyable and safer off-road experience.

Off-road suspension seats, while offering significant comfort advantages, have some notable drawbacks. A common issue is “bottoming out,” where the suspension fully compresses during aggressive riding, resulting in a jarring impact for the occupant. The movement of the seat can also loosen safety harnesses, compromising their effectiveness in an emergency. Furthermore, suspension seats are significantly more expensive and more complex than standard seats, generally requiring increased maintenance and carrying a higher risk of failure.

Given that off-road vehicles routinely travel over very rough terrain, such as mountainous regions, there is a desire to improve the performance of off-road vehicles, improve overall comfort during off-roading, while at the same reducing the mechanical complexity of such vehicles.

### SUMMARY

A system and methods are provided for a suspension seating system for improving the comfort of vehicle occupants traveling over rough terrain. The seating system comprises a suspension system coupled with a seat frame configured to be covered by a suitable padding material. The seat frame can comprise a seat base, a seat back, or a combination thereof. The suspension system includes transverse straps that are interlaced with longitudinal straps. The straps are suspended across the suspension system by support rods coupled with opposite sides of the seat frame by adjustable fasteners. The adjustable fasteners enable aligning the support rods to arrange the transverse and longitudinal straps across the length and width of the suspension system. The adjustable fasteners can include a spring mechanism for maintaining the suspension system under an optimal tension to extend the longevity of the suspension seating system.

In another exemplary embodiment, a system for a suspension seat comprises: a seat frame; a plurality of longitudinal straps; a plurality of transverse straps interlaced with the plurality of longitudinal straps; two or more transverse support rods for suspending the plurality of longitudinal straps across the seat frame; two or more longitudinal support rods for suspending the plurality of transverse straps across the seat frame; and adjustable fasteners for coupling the transverse support rods and the longitudinal support rods with the seat frame.

In another exemplary embodiment, the longitudinal straps comprise nylon straps having a width of at least about one inch. In another exemplary embodiment, the transverse straps comprise nylon straps having a width of at least about one inch.

In another exemplary embodiment, the plurality of longitudinal straps comprises a number of longitudinal straps that equals the number of transverse straps comprising the plurality of transverse straps. In another exemplary embodiment, the plurality of longitudinal straps comprises a number of longitudinal straps that differs from the number of transverse straps comprising the plurality of transverse straps.

In another exemplary embodiment, opposite ends of each of the plurality of longitudinal straps terminates in a loop portion. In another exemplary embodiment, the loop portion is configured to be mounted onto any one of the two or more transverse support rods and the two or more longitudinal support rods.

In another exemplary embodiment, two or more adjustable fasteners couple each of the two or more transverse support rods with the seat frame. In another exemplary embodiment, the two or more transverse support rods are aligned with each other, such that the plurality of longitudinal straps is arranged roughly uniformly across the width of the suspension system.

In another exemplary embodiment, two or more adjustable fasteners couple each of the two or more longitudinal support rods with the seat frame. In another exemplary embodiment, the two or more longitudinal support rods are parallel with each other, such that the plurality of transverse straps is arranged roughly uniformly across the length of the suspension system.

In another exemplary embodiment, the adjustable fasteners comprise nuts and bolts that are configured to fixedly attach the transverse support rods and the longitudinal support rods to the seat frame. In another exemplary embodiment, the positions of the transverse support rods and the longitudinal support rods relative to the seat frame can be adjusted by tightening or loosening the nuts and bolts.

In an exemplary embodiment, a method for a suspension seat comprises: forming a seat frame; arranging a plurality of longitudinal straps in the seat frame; interlacing a plurality of transverse straps with the plurality of longitudinal straps; configuring two or more transverse support rods for suspending the plurality of longitudinal straps across the seat frame; configuring two or more longitudinal support rods for suspending the plurality of transverse straps across the seat frame; and configuring adjustable fasteners for coupling the transverse support rods and the longitudinal support rods with the seat frame.

In another exemplary embodiment, configuring the two or more adjustable fasteners includes coupling each of the two or more transverse support rods with the seat frame. In another exemplary embodiment, configuring the two or more transverse support rods includes aligning the two or more transverse support rods with each other, such that the plurality of longitudinal straps is arranged roughly uniformly across the width of the suspension system.

In another exemplary embodiment, configuring the two or more adjustable fasteners includes coupling each of the two or more longitudinal support rods with the seat frame. In another exemplary embodiment, configuring the two or more longitudinal support rods includes aligning the two or more longitudinal support rods parallel with each other, such that the plurality of transverse straps is arranged roughly uniformly across the length of the suspension system.

In another exemplary embodiment, configuring the adjustable fasteners comprises configuring nuts and bolts to fixedly attach the transverse support rods and the longitudinal support rods to the seat frame. In another exemplary embodiment, configuring the two or more transverse support rods and the two or more longitudinal support rods includes positioning of the transverse support rods and the longitudinal support rods relative to the seat frame such that plurality of transverse straps and the plurality of longitudinal straps can be adjusted by tightening or loosening the nuts and bolts.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a perspective view of an exemplary embodiment of a suspension seat base that includes a suspension system, according to the present disclosure;

FIG. 2 illustrates a top view of an exemplary embodiment of a suspension seat base that includes a suspension system in accordance with the present disclosure;

FIG. 3 illustrates a bottom view of an exemplary embodiment of a suspension seat base that includes a suspension system, according to the present disclosure;

FIG. 4 illustrates a perspective view of an exemplary embodiment of a suspension seat that includes a suspension system incorporated into a seat back frame and a seat base frame, according to the present disclosure;

FIG. 5 illustrates a top view of an exemplary embodiment of a suspension seat base that includes a suspension system in accordance with the present disclosure;

FIG. 6 illustrates a bottom view of an exemplary embodiment of a suspension seat base that includes a suspension system, according to the present disclosure;

FIG. 7 illustrates an isometric view of an exemplary embodiment of an attachment assembly that is configured to couple a seat strap with a seat frame according to the present disclosure;

FIG. 8 illustrates an exemplary embodiment of a seat strap coupled with support rings at opposite ends of the seat strap, in accordance with the present disclosure; and

FIG. 9 illustrates an exemplary embodiment of a support plate configured to couple a seat strap with a seat frame according to the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the suspension seat system and methods disclosed herein may be practiced without these specific details. In other instances, specific numeric references such as “first fastener,” may be made. However, the specific numeric reference should not be interpreted as a literal sequential order but rather interpreted that the “first fastener” is different than a “second fastener.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes a system and methods for a suspension seating system that improves the comfort of vehicle occupants traveling over rough terrain. The seating system comprises a suspension system coupled with a seat frame configured to be covered by a suitable padding material. The seat frame can comprise a seat base, a seat back, or a combination thereof. The suspension system includes transverse straps that are interlaced with longitudinal straps. The transverse and longitudinal straps are suspended across the suspension system by support rods coupled with opposite sides of the seat frame by adjustable fasteners. The adjustable fasteners enable aligning the support rods to arrange the transverse and longitudinal straps across the length and width of the suspension system. The adjustable fasteners can include a spring mechanism for maintaining the suspension system under an optimal tension to extend the longevity of the suspension seating system.

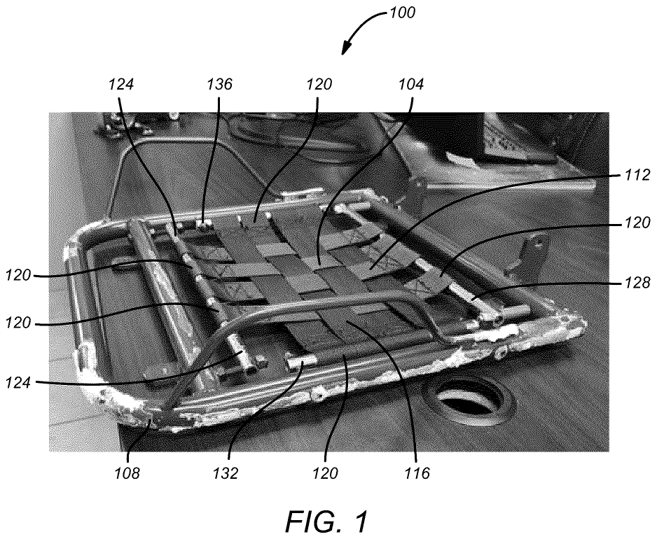

FIG. 1 illustrates a perspective view of an exemplary embodiment of a suspension seat base 100 that includes a suspension system 104, according to the present disclosure. The suspension seat base 100 includes a seat frame 108 that is configured to be covered by high-density molded foam, or other suitable padding material for a seat. In some embodiments, the seat frame 108 comprises a 1-inch outer diameter tubing seat frame. It is contemplated that the seat frame 108 provides unmatched comfort and durability, as well as providing long-lasting protection for vehicle occupants. Although the illustrated embodiment shows only the seat base 108, it should be borne in mind that the suspension system 104 can be implemented in a seat back, without limitation.

The suspension system 104 comprises multiple longitudinal straps 112 that are interlaced with multiple transverse straps 116. The interlacing of the straps 112, 116 provides a web-style suspension system that resembles military helicopter seats and can be incorporated into both the seat base 100 as well as a seat back (not shown). In some embodiments, the straps 112, 116 comprise 1-inch wide nylon webbing that is configured to provide superior damping and load distribution as compared to traditional tarp-style seat suspension systems. In some embodiments, however, the straps 112, 116 may have widths that are greater than 1-inch. In some embodiments, the longitudinal straps 112 may have a different width than the width of the transverse straps 116. Further, in some embodiments, the number of longitudinal straps 112 may be different than the number of transverse straps 116 comprising the suspension system 104, without limitation.

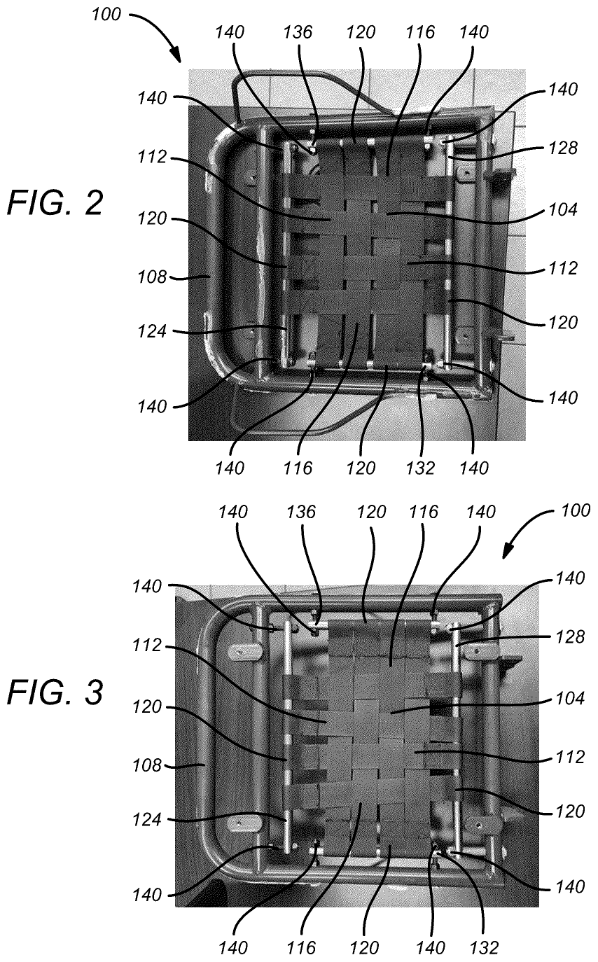

As shown in FIGS. 1-3, each of the straps 112, 116 terminates in a loop portion 120 disposed at opposite ends of the strap. The loop portions 120 comprising the longitudinal straps 112 are mounted onto a transverse support rod that is coupled with the seat frame 108. Thus, as shown in FIGS. 2-3, the longitudinal straps 112 are attached to a front transverse support rod 124 and a rear transverse support rod 128 that are both fastened to the seat frame 108. Similarly, the transverse straps 116 are attached to a first longitudinal support rod 132 and a second longitudinal support rod 136 that are both fastened to the seat frame 108. As will be appreciated, the support rods 124, 128, 132, and 136 are made of a generally rigid material, such as metal, that is suitable for supporting the weight of a seated occupant. Further, the support rods 124, 128, 132, and 136 are configured to withstand jarring impulse forces due to the vehicle traveling over rough terrain.

As best shown in FIGS. 2-3, an adjustable fastener 140 couples opposite ends of each of the support rods 124, 128, 132, and 136 with the seat frame 108. As such, two adjustable fasteners 140 couple each of the transverse support rods 124, 128 with the seat frame 108. The transverse support rods 124, 128 are parallel with each other, such that the longitudinal straps 112 are arranged roughly uniformly across the width of the suspension system 104. Further, two adjustable fasteners 140 couple each of the longitudinal support rods 132, 136 with the seat frame 108. The longitudinal support rods 132, 136 are parallel with each other, such that the transverse straps 116 are arranged roughly uniformly across the length of the suspension system 104.

The adjustable fasteners 140 may comprise any mechanism whereby the support rods 124, 128, 132, and 136 can be coupled with the seat frame 108 so as to support the longitudinal and transverse straps 112, 116 as described herein. In some embodiments, the adjustable fasteners 140 can comprise nuts and bolts that are configured to fixedly attach the support rods 124, 128, 132, and 136 to the seat frame 108. In such embodiments, the positions of the support rods 124-136 relative to the seat frame 108 can be adjusted by tightening or loosening the nuts and bolts comprising the fasteners 140. Thus, the adjustable fasteners 140 can be used to advantageously affect the tension of the longitudinal and transverse straps 112, 116 to maintain a secure fit of the suspension system 104 over time. In some embodiments, the tension of the longitudinal and transverse straps 112, 116 can be further enhanced by incorporating one or more springs into the adjustable fasteners 140. As such, it is contemplated that, in some embodiments, the adjustable fasteners 140 comprise any mechanism capable of exerting spring forces on the support rods 124-136 such that the longitudinal and transverse straps 112, 116 are maintained under an advantageous tension.

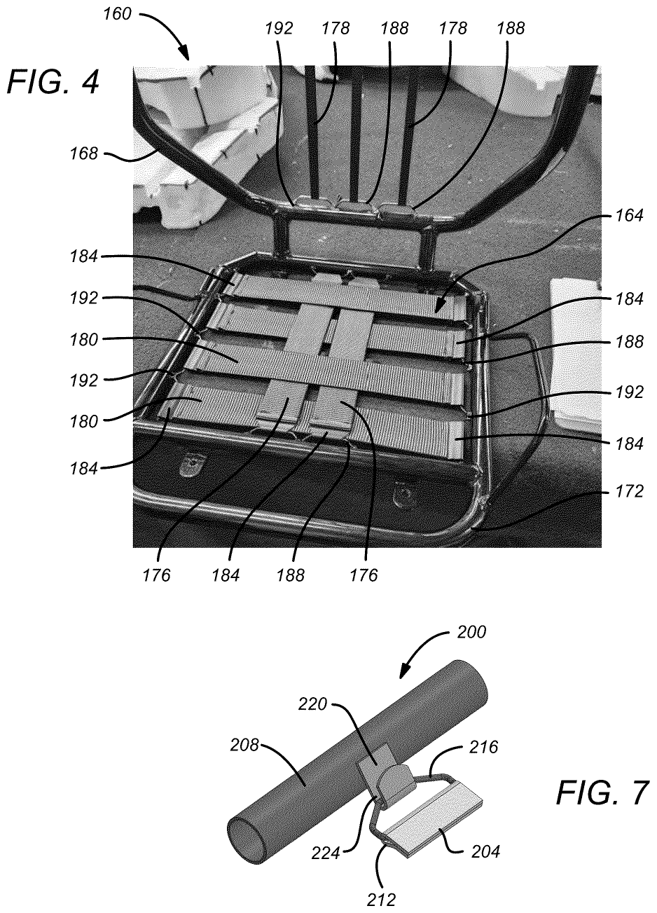

FIG. 4 illustrates a perspective view of an exemplary embodiment of a suspension seat 160 that includes a suspension system 164 system incorporated into a seat back frame 168 and a seat base frame 172, according to the present disclosure. The seat back frame 168 and the seat base frame 172 are configured to be covered by high-density molded foam, or other suitable padding material for a seat. In some embodiments, either or both of the seat frames 168, 172 comprise a 1-inch outer diameter tubing seat frame. As mentioned herein, it is contemplated that the seat frames 168, 172 provide unmatched comfort and durability, as well as providing long-lasting protection for vehicle occupants.

The suspension system 164 comprises multiple longitudinal straps 176 that are interlaced with multiple transverse straps 180. The interlacing of the straps 176, 180 provides a web-style suspension system that resembles military helicopter seats and can be incorporated into both the seat base frame 172 as well as the seat back frame 168. In the illustrated embodiment, multiple back straps 178 are vertically oriented in the seat back frame 168. In some embodiments, the seat back frame 168 can include multiple horizontal that are interlaced with the back straps 178 similarly to the straps 176. 180 shown in FIG. 4.

In some embodiments, the straps 176, 180 comprise 1-inch wide nylon webbing that is configured to provide superior damping and load distribution as compared to traditional tarp-style seat suspension systems. In some embodiments, however, the straps 176, 180 may have widths that are greater than 1-inch. In some embodiments, the longitudinal straps 176 may have a different width than the width of the transverse straps 180. Further, in some embodiments, the number of longitudinal straps 176 may be different than the number of transverse straps 180 comprising the suspension system 164, without limitation. For example, as shown in FIG. 4, two longitudinal straps 176 are interlaced with four transverse straps 180.

As shown in FIGS. 4-6, each of the straps 176, 180 terminates in hook portions 184 disposed at opposite ends of the strap. Each of the hook portions 184 is configured to be mounted onto a support rod 188 that is attached to opposite sides of the seat base frame 172. In general, the hook portions 184 are made of a rigid material, such as metal or molded plastic, and are attached to the straps 176, 180. In some embodiments, the hook portions 184 can be molded onto the straps 176, 180. In some embodiments, the hook portions 184 can be threaded onto the straps 176, 180. In some embodiments, the hook portions 184 comprising metal can be pressed or crimped onto the straps 176, 180. It is contemplated that the hook portions 184 can be attached to the straps 176, 180 by way of any of various means, without limitations.

The support rods 188 are made of a generally rigid material, such as metal, that is suitable for supporting the weight of a seated occupant. As shown in FIG. 4, the support rods 188 can also be attached to the seat back frame 168 to support the back straps 178. The support rods 188 are configured to withstand jarring impulse forces due to the vehicle traveling over rough terrain. Further, the support rods 188 are each coupled with the seat frames 168, 172 by way of attachment points 192. In the illustrated embodiment of FIGS. 4-6, the attachment points 192 comprise weld points between opposite ends of the support rods 188 and the seat frames 168, 172. In some embodiments, however, the attachment points 192 can comprise any of various devices for attaching the support rods 188 to the seat frames 168, 172, without limitation.

In general, the straps 176, 180 are made of an elastic material capable of stretching under the weight of a seated occupant. As shown in FIG. 6, however, inelastic straps 196 can be mounted in parallel with one or more of the straps 176, 180 to limit the distance to which the straps 176, 180 can be stretched. In the illustrated embodiment, inelastic straps 196 are coupled with two of four transverse straps 180 to support the weight of a seated occupant and to withstand jarring impulse forces due to the vehicle traveling over rough terrain without sacrificing comfort provided by the suspension system 164. As will be appreciated, the inelastic straps 196 can be attached to the hook portions 184 in concert with the ends of the strap 180. More specifically, in some embodiments, the hook portions 184 can be molded and/or threaded directly onto ends of the inelastic strap 196 and the transverse strap 180.

Moreover, in some embodiments, a midpoint 198 of the inelastic straps 196 can be attached to a midpoint of the transverse strap 180. In the illustrated embodiment of FIG. 6, the midpoint 198 is sewn to the midpoint of the transverse strap 180 to prevent excessive drooping of the inelastic strap 196 when the transverse strap 180 is in an unstretched state.

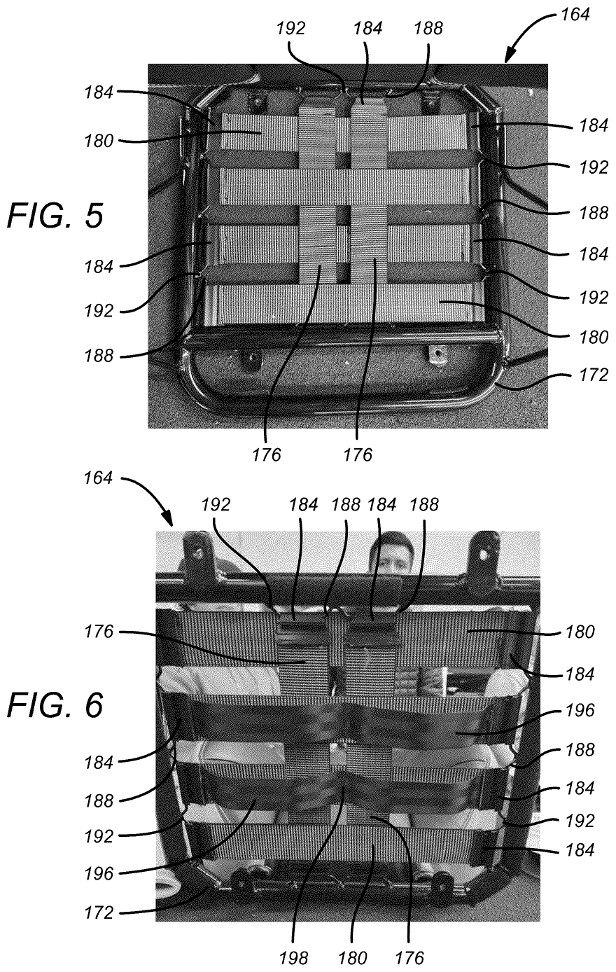

FIG. 7 illustrates an exemplary embodiment of an attachment assembly 200 configured to couple a seat strap 204 with a seat frame 208. The seat frame 208 is configured to be covered by high-density molded foam, or other suitable padding material for a seat. In some embodiments, the seat frame 208 comprises a 1-inch outer diameter tubing seat frame. In some embodiments, the seat frame 208 can comprise either a seat back frame 168 or a seat base frame 172, as described herein. The seat strap 204 can comprise any of the straps 112, 116, 176, 180. Thus, the seat strap 204 is configured to be interlaced to provide a web-style suspension system that provides superior damping and load distribution than traditional tarp-style seat suspension systems. In some embodiments, the seat straps 204 comprise 1-inch wide nylon webbing, as described herein. However, in some embodiments, any number of the seat straps 204 can have widths that are greater than 1-inch, such as, by way of non-limiting example, 2-inch wide nylon straps, without limitation.

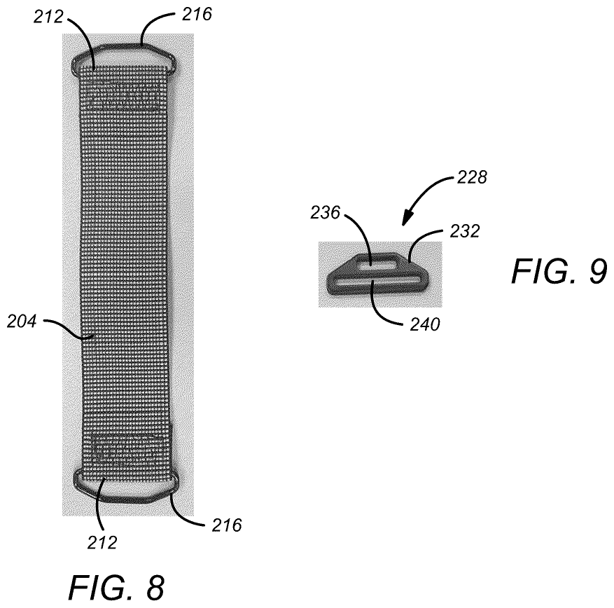

As shown in FIG. 7, the seat strap 204 terminates in a loop portion 212 disposed at the end of the strap 204. The loop portion 212 is configured to be mounted onto a support ring 216 that is configured to be coupled with the seat frame 208. In one embodiment, the loop portion 212 can be mounted onto the support ring 216 by extending the end of the seat strap 204 through the support ring 216 and then sewing the end to the seat strap 204, as best shown in FIG. 8. The support ring 216 is made of a generally rigid material, such as metal, that is suitable for supporting the weight of a seated occupant.

The support ring 216 can be coupled with the seat frame 208 by way of a clip 220 that is fastened or welded onto the seat frame 208. In the illustrated embodiment, the clip 220 includes a recess 224 configured to receive the support ring 216. As such, the clip 220 comprises a rigid material, such as metal, that is capable of supporting the weight of a seated occupant.

As best shown in FIG. 9, an embodiment of a support ring can comprise a support plate 228 configured to couple the seat strap 204 with the seat frame 208. The support plate 228 comprises a plate 232 having a first opening 236 and a second opening 240. The first opening 236 has a shape and a size that is suitable for being coupled with the seat frame 208 by way of the clip 220 shown in FIG. 7. The second opening 240 has a shape and a size configured to receive the loop portion 212 (see FIG. 8). As will be appreciated, the support plate 228 can be coupled with the strap 204 by extending the end of the seat strap 204 through the second opening 240 and then sewing the end to the seat strap 204, as best shown in FIG. 8. Like the support ring 216, the support plate 228 is made of a generally rigid material, such as metal, that is capable of supporting the weight of a seated occupant.

While the suspension seat system and methods have been described in terms of particular variations and illustrative figures, those of ordinary skill in the art will recognize that the suspension seat system is not limited to the variations or figures described. In addition, where methods and steps described above indicate certain events occurring in certain order, those of ordinary skill in the art will recognize that the ordering of certain steps may be modified and that such modifications are in accordance with the variations of the suspension seat system. Additionally, certain of the steps may be performed concurrently in a parallel process, when possible, as well as performed sequentially as described above. To the extent there are variations of the suspension seat system, which are within the spirit of the disclosure or equivalent to the suspension seat system found in the claims, it is the intent that this patent will cover those variations as well. Therefore, the present disclosure is to be understood as not limited by the specific embodiments described herein, but only by scope of the appended claims.

What is claimed is:

1. A system for a suspension seat, comprising:
a seat frame;
a plurality of longitudinal straps;
a plurality of transverse straps interlaced with the plurality of longitudinal straps;
two or more transverse support rods for suspending the plurality of longitudinal straps across the seat frame;
two or more longitudinal support rods for suspending the plurality of transverse straps across the seat frame; and
adjustable fasteners for coupling the transverse support rods and the longitudinal support rods with the seat frame.

2. The system of claim 1, wherein the longitudinal straps comprise nylon straps having a width of at least about one inch.

3. The system of claim 1, wherein the transverse straps comprise nylon straps having a width of at least about one inch.

4. The system of claim 1, wherein the plurality of longitudinal straps comprises a number of longitudinal straps that equals the number of transverse straps comprising the plurality of transverse straps.

5. The system of claim 1, wherein the plurality of longitudinal straps comprises a number of longitudinal straps that differs from the number of transverse straps comprising the plurality of transverse straps.

6. The system of claim 1, wherein opposite ends of each of the plurality of longitudinal straps terminates in a loop portion.

7. The system of claim 6, wherein the loop portion is configured to be mounted onto any one of the two or more transverse support rods and the two or more longitudinal support rods.

8. The system of claim 1, wherein two or more adjustable fasteners couple each of the two or more transverse support rods with the seat frame.

9. The system of claim 8, wherein the two or more transverse support rods are aligned with each other, such that the plurality of longitudinal straps is arranged roughly uniformly across the width of the suspension system.

10. The system of claim 1, wherein two or more adjustable fasteners couple each of the two or more longitudinal support rods with the seat frame.

11. The system of claim 10, wherein the two or more longitudinal support rods are parallel with each other, such that the plurality of transverse straps is arranged roughly uniformly across the length of the suspension system.

12. The system of claim 1, wherein the adjustable fasteners comprise nuts and bolts that are configured to fixedly attach the transverse support rods and the longitudinal support rods to the seat frame.

13. The system of claim 12, wherein the positions of the transverse support rods and the longitudinal support rods relative to the seat frame can be adjusted by tightening or loosening the nuts and bolts.

14. A method for a suspension seat, comprising:
forming a seat frame;
arranging a plurality of longitudinal straps in the seat frame;
interlacing a plurality of transverse straps with the plurality of longitudinal straps;
configuring two or more transverse support rods for suspending the plurality of longitudinal straps across the seat frame;
configuring two or more longitudinal support rods for suspending the plurality of transverse straps across the seat frame; and
configuring adjustable fasteners for coupling the transverse support rods and the longitudinal support rods with the seat frame.

15. The method of claim 14, wherein configuring the two or more adjustable fasteners includes coupling each of the two or more transverse support rods with the seat frame.

16. The method of claim 15, wherein configuring the two or more transverse support rods includes aligning the two or more transverse support rods with each other, such that the plurality of longitudinal straps is arranged roughly uniformly across the width of the suspension system.

17. The method of claim 14, wherein configuring the two or more adjustable fasteners includes coupling each of the two or more longitudinal support rods with the seat frame.

18. The method of claim 17, wherein configuring the two or more longitudinal support rods includes aligning the two or more longitudinal support rods parallel with each other, such that the plurality of transverse straps is arranged roughly uniformly across the length of the suspension system.

19. The method of claim 14, wherein configuring the adjustable fasteners comprises configuring nuts and bolts to fixedly attach the transverse support rods and the longitudinal support rods to the seat frame.

20. The method of claim 19, wherein configuring the two or more transverse support rods and the two or more longitudinal support rods includes positioning of the transverse support rods and the longitudinal support rods relative to the seat frame such that plurality of transverse straps and the plurality of longitudinal straps can be adjusted by tightening or loosening the nuts and bolts.
